(19) United States
(12) Patent Application Publication
(10) Pub. No.: US 2005/0270426 A1
(43) Pub. Date: Dec. 8, 2005

(54) APPARATUS AND METHOD FOR CROSS COLOR EFFECT ELIMINATION

(76) Inventors: Jen-Shi Wu, Hsin-Chu City (TW); Wen-Chang Chang, Tai-Chung City (TW)

Correspondence Address: NORTH AMERICA INTELLECTUAL PROPERTY CORPORATION, P.O. BOX 506, MERRIFIELD, VA, 22116, US

(21) Appl. No.: 10/908,911

(22) Filed: May 31, 2005

(30) Foreign Application Priority Data
Jun. 2, 2004 (TW) 093115841

(51) Int. Cl. H04N 5/217

(52) U.S. Cl. 348/638; 348/666; 348/624

(57) ABSTRACT

A video signal comprises a chrominance signal and a luminance signal. A cross color effect elimination apparatus for utilizing a first carrier wave to eliminate a cross color effect from the video signal includes a cross color estimator coupled to the video signal for estimating a cross color component of the video signal, a modulator coupled to the cross color estimator and the first carrier wave for utilizing the first carrier wave to convert the cross color component into a luminance compensation component, and an adder coupled to the luminance signal and the modulator for adding the luminance signal to the luminance compensation component to thereby generate a compensated luminance signal.

### BACKGROUND

The invention relates to video signal processing devices and, more particularly, to eliminating the influence of a cross color effect on a video signal.

In a typical video signal transceiver such as in an American National Television System Committee (NTSC) transceiver system or in an European Phase Alternating Line (PAL) transceiver system, a video signal is actually comprised of a chrominance signal C corresponding to color information of the video signal and a luminance signal Y corresponding to intensity information of the video signal. Using the American NTSC standard as an example, the luminance signal Y is transmitted with a frequency band ranging from approximately 0 MHz to 4.2 MHz, while the chrominance signal C is formed by transmitting a carrier frequency of 3.58 MHz with a first signal U sin(wt) plus a second signal V cos(wt). Therefore, the frequency band of the chrominance signal C ranges from approximately 2.3 MHz to 4.2 MHz.

After receiving a video signal being formed as a mixed chrominance signal C and luminance signal Y, a luminance and chrominance (Y/C) separation operation must first be performed. This operation separates the luminance signal Y and the chrominance signal C (formed by U sin(wt)+V cos(wt)) from the video signal. Afterwards, the U signal and the V signal from within the chrominance signal C are respectively demodulated. Next, a (Y, U, V) domain video signal is transferred to an (R, G, B) domain video signal, which is thereafter displayed on a corresponding display device.

However, because the luminance signal Y and the chrominance signal C are transmitted with a portion of the signals using the same frequency band, when performing the Y/C separation operation, it is very difficult to perform an accurate separation of the luminance signal Y and the chrominance signal C. Normally, a signal degradation of the signals will occur due to a phenomenon known as the cross talk effect during the Y/C separation operation. Generally speaking, there are two different situations that could occur due to the cross talk effect. Firstly, a situation could occur where a part of the luminance signal Y is mistakenly judged to be of the chrominance signal C. This effect is referred to as a cross color effect and results in a change of the color pattern of the video signal. Secondly, a situation could occur where a part of the chrominance signal C is mistakenly judged to be of the luminance signal Y. This effect is referred to as a cross luminance effect.

Visual systems designed for the human eye are very sensitive to the cross color effect. Therefore, providing a solution to prevent degradation of video signals due to the cross color effect is an important problem facing visual system designers. In a related art method, U.S. Pat. No. 5,305,120 discloses a technique for suppressing to a specific degree the cross color effect of a video signal. However, when the cross color effect is being produced, a part of the luminance signal (ΔY) is mistakenly judged to be chrominance signal. That is, an original chrominance signal C is mistakenly separated as C+ΔY, and an original luminance signal Y is mistakenly separated as Y−ΔY. Although the above technique of the related art can suppress the mistaken part of the final chrominance signal (i.e., ΔY), the missing part of the luminance signal Y (i.e., −ΔY) is not compensated for. Because of this, the resulting video signal displayed on a corresponding display device continues to be in error. That is, the final video signal has a chrominance signal of C but a luminance signal of Y−ΔY.

### SUMMARY

One objective of the claimed invention is therefore to provide a method and apparatus for eliminating the influence of the cross color effect on both a chrominance signal and a luminance signal of a video signal, to thereby solve the above-mentioned problem.

According to an exemplary embodiment of the claimed invention, a cross color effect elimination apparatus is disclosed for utilizing a first carrier wave to eliminate a cross color effect from a video signal. The video signal comprises a chrominance signal and a luminance signal, and the cross color effect elimination apparatus comprises a cross color estimator coupled to the video signal for estimating a cross color component of the video signal; a modulator coupled to the cross color estimator and the first carrier wave for utilizing the first carrier wave to convert the cross color component into a luminance compensation component; and an adder coupled to the luminance signal and the modulator for adding the luminance signal to the luminance compensation component to thereby generate a compensated luminance signal.

According to another exemplary embodiment of the claimed invention, a cross color effect processing apparatus is disclosed for processing a cross color effect of a video signal. The video signal comprises a chrominance signal and a luminance signal, and the cross color effect processing apparatus comprises a feature extractor coupled to the luminance signal for extracting a candidate component that is responsible for causing the cross color effect; a demodulator coupled to the feature extractor for utilizing a first carrier wave to convert the candidate component to a candidate cross color component; a cross color estimator coupled to the chrominance signal for estimating a chrominance cross color component corresponding to the chrominance signal; a phase detector coupled to the demodulator and the cross color estimator for comparing the candidate cross color component and the chrominance cross color component, and for outputting a corresponding difference signal; and a feedback circuit coupled to the phase detector and the demodulator for generating a first carrier wave according to the difference signal.

According to another exemplary embodiment of the claimed invention, a method of cross color effect elimination is disclosed for eliminating a cross color effect from a video signal. The video signal comprises a chrominance signal and a luminance signal, and the method comprises the following steps: (a) estimating a cross color component from the chrominance signal; (b) utilizing a first carrier wave to convert the cross color component to a luminance compensation component, wherein the first carrier wave and a carrier wave used during demodulation of the video signal have the same frequency and phase; and (c) adding the luminance signal with the luminance compensation component to thereby generate a compensated luminance signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a cross color effect elimination apparatus according to a first exemplary embodiment of the present invention.

FIG. 2 is a block diagram of a cross color effect processor apparatus according to a second exemplary embodiment of the present invention.

FIG. 3 is a block diagram of an integrated cross color effect elimination apparatus according to a third exemplary embodiment of the present invention.

FIG. 4 is a flowchart describing operations of eliminating the influence of the cross color effect on a video signal according to an exemplary embodiment of the present invention.

### DETAILED DESCRIPTION

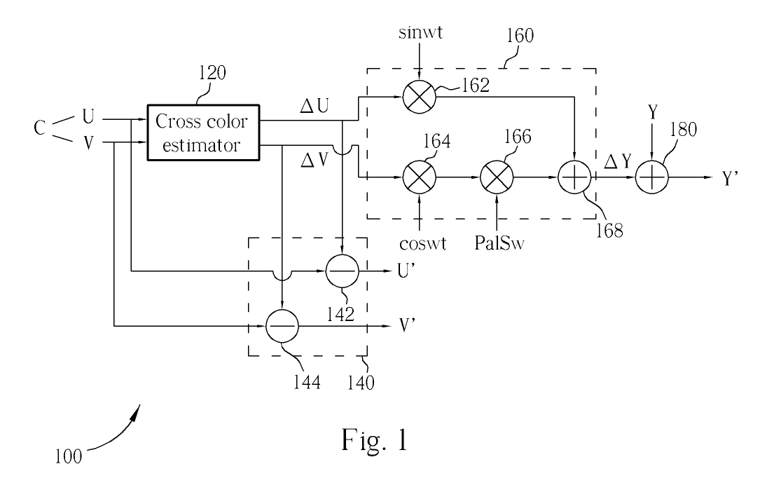

Please refer to FIG. 1. FIG. 1 shows a block diagram of a cross color effect elimination apparatus 100 according to a first exemplary embodiment of the present invention. The cross color effect elimination apparatus 100 utilizes a first carrier wave cos(wt) and a second carrier wave sin(wt) to eliminate the influence of a cross talk effect on a video signal. The video signal includes a chrominance signal C (being formed by a U signal and a V signal) and a luminance signal Y. In this embodiment, the cross color eliminating apparatus 100 comprises a cross color estimator 120, a subtractor module 140, a modulator 160, and an adding unit being implemented in FIG. 1 as adder 180.

The cross color estimator 120 is coupled to the chrominance signal C and uses a two dimensional or a three dimensional phase relationship of the chrominance signal C to filter the chrominance signal C and thereby generate cross color components. These cross color components include a cross color U component (i.e., ΔU), and a cross color V component (i.e., ΔV). The primary reason for the generation of the cross color components is that after the video signal has undergone Y/C separation, a part of the luminance signal Y is mistakenly judged to be chrominance signal C, and this results in the chrominance signal C having more than the original components, which are then demodulated into cross color components (ΔU and ΔV). Therefore, the primary function of the subtractor module 140 is to remove the cross color components (ΔU and ΔV) from the chrominance signal C to form a suppressed chrominance signal (i.e., a correct chrominance signal not being influenced by the cross color effect). In this embodiment, the subtractor module 140 includes a first subtractor 142 used for subtracting the ΔU component from the U signal to thereby produce a U′ signal, and a second subtractor 144 used for subtracting the ΔV component from the V signal to thereby produce a V′ signal. The signals U′ and V′ outputted from the subtractor module 140 are substantially the same as the suppressed chrominance signals of the above described related art.

Because the cross color effect not only influences the chrominance signal C, but also results in an incorrect luminance signal Y, in this embodiment of the present invention, the main function of the modulator 160 is to utilize a first carrier wave cos(wt) and a second carrier wave sin(wt) to convert the cross color components into a luminance compensation component ΔY. Afterwards, an adding unit (e.g., second adder 180) is used to add the original luminance signal Y and the luminance compensation component ΔY generated by the modulator 160 to thereby produce a compensated luminance signal Y′. In this embodiment, the modulator 160 includes a first multiplier 162 utilized for multiplying the ΔU cross color component with the second carrier wave sin(wt), a second multiplier 164 utilized for multiplying the ΔV cross color component with the first wave signal cos(wt), a third multiplier 166 coupled to the second multiplier 164 utilized for performing processing according to the Europea video signal standard, and a first adder 168 coupled to the first multiplier 162 and the third multiplier 166 utilized for generating the luminance compensation component ΔY by adding the outputs of the first multiplier 162 and the third multiplier 166. It should be noted that the third multiplier 166 is required because according to the Europea video signal standard, two successive video frames have a phase difference of 180 degrees. Therefore, although in this embodiment the modulator 160 includes the third multiplier 166, in situations not requiring processing according to the Europea video signal standard, the third multiplier 166 can be omitted from the modulator 160.

In order to utilize the first embodiment shown in FIG. 1 to generate a correct (i.e., compensated) luminance signal Y′, one prerequisite is that the first carrier wave cos(wt) and the second carrier wave sin(wt) must have the same phase as the carrier waves used when the original chrominance signal C is demodulated to form the U signal and the V signal. Only in this situation will the compensated luminance signal Y′ have the influence of the cross color effect eliminated and be the correct luminance signal. If the phase of the signals is not the same, the modulator 160 will not be able to correctly convert the cross color components into a luminance compensation signal ΔY. Because of this, in a situation where the production of a first carrier wave cos(wt) and a second carrier wave sin(wt) having correct phase relationships can be achieved (e.g., in a video signal receiver), using the cross color effect elimination apparatus 100 shown in the embodiment of FIG. 1 in combination with first carrier wave cos(wt) and a second carrier wave sin(wt) having the correct phases will eliminate the influence of the cross color effect from both the chrominance signal C and the luminance signal Y.

However, in some video signal receivers it may not be possible to know the phase information of the carrier wave signals used during the demodulation of the video signal will only correct the chrominance signal C. Therefore, although capable of removing the influence of the cross color effect on the chrominance signal C, only using the cross color effect elimination apparatus 100 shown in the embodiment of FIG. 1 will be unable to account for the influence of the cross color effect on the luminance signal Y and will be unable to produce a compensated luminance signal Y′. The primary reason for this inability is that the cross color effect elimination apparatus 100 shown in FIG. 1 must use a first carrier wave cos(wt) and a second carrier wave sin(wt) having the correct phase. In the situation where phase information of the carrier waves used during demodulation is unknown, the cross color effect elimination apparatus 100 instead must operate in conjunction with an apparatus (referred to in the following as a cross color effect processor) that can produce a first wave signal cos(wt) and a second wave signal sin(wt) having the correct phase. In this way, influences of the cross color effect can be correctly eliminated from both the chrominance signal C and the luminance signal Y.

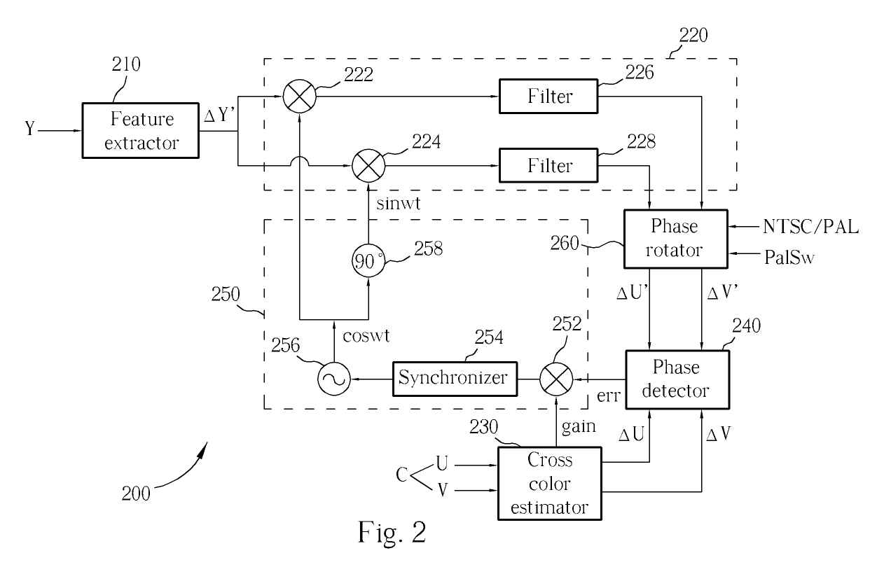

Please refer to FIG. 2. FIG. 2 shows a block diagram of a cross color effect processor apparatus 200 according to a second exemplary embodiment of the present invention. The cross color effect processor apparatus 200 is coupled to a video signal, and the video signal includes a chrominance signal C and a luminance signal Y. In this embodiment, the cross color effect processor apparatus 200 comprises a feature extractor 210, a demodulator 220, a cross color estimator 230, a phase detector 240, a feedback circuit 250, and a phase rotator 260. Please note, the phase rotator 260 is used primarily for performing phase rotation according to the Europea video signal standard. In situations not requiring compliance with the Europea video signal standard, the phase rotator 260 can be omitted from the embodiment shown in FIG. 2.

The following is an explanation of the feature extractor 210. In one embodiment, the feature extractor 210 is implemented as a band pass filter, where for NTSC the center of the band pass filter is located at 3.58 MHz, and for PAL the center of the band pass filter is located at 4.43 MHz. Additionally, the feature extractor 210 is also a two dimensional boundary line or a diagonal line detection device used to pick out most likely cross color components of a video frame. After the Y/C separation operation, the luminance signal Y still has a portion that is possibly incorrect due to a cross color effect component (referred herein as a candidate component ΔY′). That is, the frequency spectrum used by the chrominance signal C for the NTSC video signal standard ranges from 2.3 MHz to 4.2 MHz, and for PAL video signal standard ranges from 3 MHz to 5.7 MHz. Therefore, using a feature extractor 210 having a band pass filter property allows the candidate component ΔY′ to be extracted from the luminance signal Y.

The demodulator 220 is coupled to the feature extractor 210 and, in this embodiment, includes a first multiplier 220 utilized for multiplying the candidate component ΔY′ with the first carrier wave cos(wt), a second multiplier 224 utilized for multiplying the candidate component ΔY′ with the second carrier wave sin(wt), a first filter 226 (which can be implemented as a low pass filter) utilized for filtering the output of the first multiplier 222, and a second filter 228 (which can also be implemented as a low pass filter) utilized for filtering the output of the second multiplier 224. The purpose of the demodulator 220 is to convert the candidate component ΔY′ to cross color components, which include the ΔU′ cross color component and the ΔV′ cross color components that are responsible for the influence of the cross color effect present in the video signal.

In the situation where the first carrier wave cos(wt) and the second carrier wave sin(wt) have correct phases, the candidate U component ΔU′ and the candidate V components ΔV′ of the two cross color components estimated by the cross color estimator 230 according to the cross color U component (ΔU) and the cross color V component (ΔV) of the chrominance signal C will have the same phase relationship. However, in the situation where the first carrier wave cos(wt) and the second carrier wave sin(wt) have a different phase relationship, the candidate cross color components and the cross color components will have different phases. In this situation, the phase detector 240 generates an error signal err according to the difference between the phase relationships. The error signal err passes through the feedback circuit 250 to adjust the phase (or the frequency) of the first carrier wave cos(wt) and the second carrier wave sin(wt). In this way, the first carrier wave cos(wt) and the second carrier wave sin(wt) are adjusted to have the correct frequency and phase.

In this embodiment, the cross color estimator 230, besides estimating the ΔU and the ΔV signals, can also output a gain signal according to the size of the ΔU and ΔV signals. The gain signal is utilized to increase the speed of the adjustment made by the feedback circuit 250. In this embodiment, the feedback circuit 250 includes a third multiplier 252 utilized for multiplying the gain signal and the error signal err, a synchronizer 254 coupled to the third multiplier 252 utilized for filtering the output of the third multiplier 252 (e.g., the synchronizer 254 can be implemented using a phase lock loop), a waveform generator 256 utilized for generating the first carrier wave cos(wt), and a phase rotator 258 coupled to the waveform generator utilized for rotating the phase of the first carrier wave cos(wt) to thereby generate the second carrier wave sin(wt). Please note, in another embodiment, the feedback circuit 250 does not include the third multiplier 252, and the error signal err is instead directly inputted to the synchronizer 254.

After undergoing the operations of the feedback circuit 250, the first carrier wave cos(wt) and the second carrier wave sin(wt) will approach the correct phases (i.e., having the same phase with the carrier waves used during the demodulation process). At this time, if the carrier waves generated by the embodiment shown in FIG. 2 are provided to the cross color effect elimination apparatus of FIG. 1, the cross color effect on both the chrominance signal C and the luminance signal Y can be correctly eliminated.

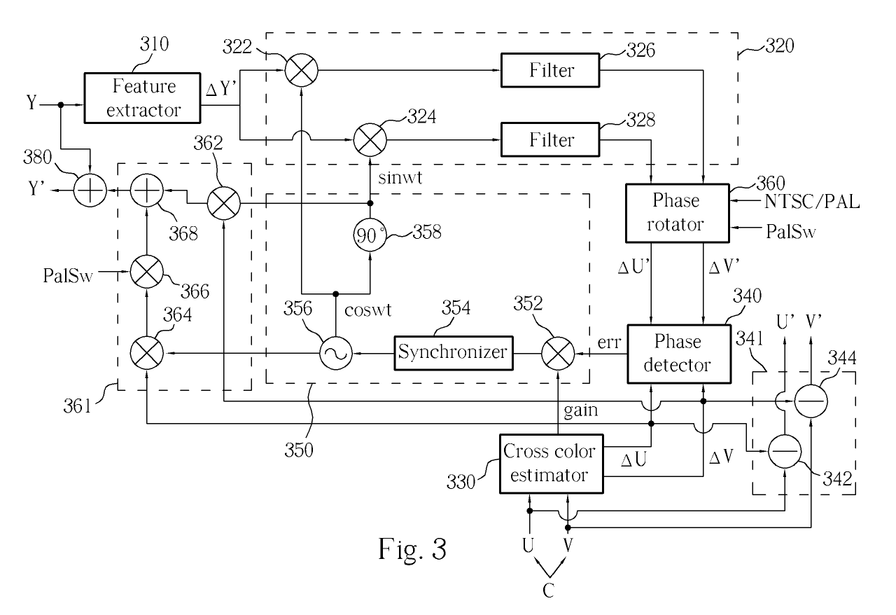

Of course, in actual implementations, the embodiments shown in FIG. 1 and FIG. 2 can be combined into a single integrated cross color effect elimination apparatus. In this way, carrier waves are generated having the correct phase relationships, and the influence of the cross color effect on both the luminance signal Y and the chrominance signal C of a video signal are simultaneously eliminated. This integrated cross color effect elimination apparatus is shown in FIG. 3. As the connections and functions of the individual elements shown in FIG. 3 have already been described, a repeated description of the operation of the embodiment shown in FIG. 3 is therefore omitted.

The present invention provides a cross color effect elimination apparatus for use in a video signal receiver. However, in certain situations such as in a continuous video storage system (e.g., DVD, VCD, etc.), the stored video signal may already be degraded due to the cross color effect. Therefore, the present invention can also be used in a video system when reading data such as the above-mentioned video data already being influenced by the cross color effect. For example, when utilized in a playback device (e.g., a DVD system), the present invention eliminates any influence of cross color effect that may be present in the stored data of a DVD disc.

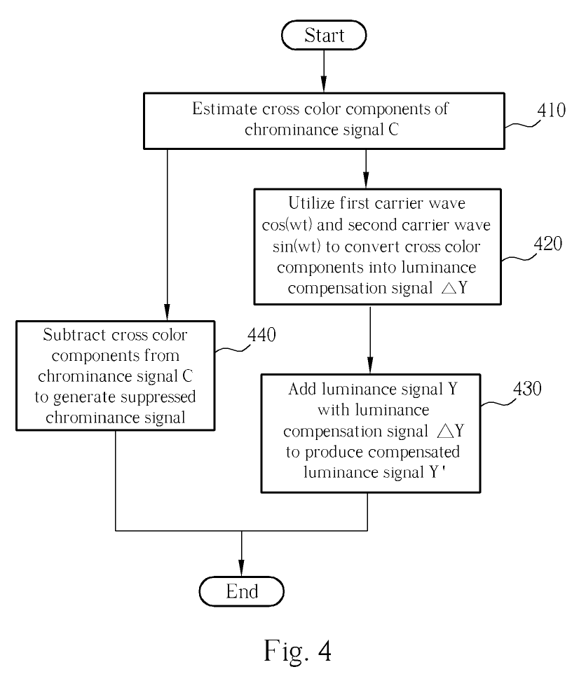

FIG. 4 shows a flowchart describing operations of eliminating the influence of the cross color effect according to an exemplary embodiment of the present invention. Generally speaking, the present invention provides a cross color effect elimination apparatus that is capable of performing the steps of the flowchart shown in FIG. 4. Provided that substantially the same result is achieved, the steps of the flowchart shown in FIG. 4 need not be in the exact order shown and need not be contiguous, that is, other steps can be intermediate. In this embodiment, the flowchart shown in FIG. 4 includes the following steps:

Step 410: Estimate cross color components of a chrominance signal C (including the cross color U component, e.g., ΔU; and the cross color V component, e.g., ΔV). For example, step 410 is implemented using the cross color estimator 120 shown in FIG. 1.

Step 420: Utilize a first carrier wave cos(wt) and a second carrier wave sin(wt) to convert the cross color components into a luminance compensation signal ΔY. Please note that the first carrier wave cos(wt) and the carrier wave used during a demodulation operation of the video signal must have the same phase relationship. For example, step 420 is performed by the modulator 160 shown in FIG. 1.

Step 430: Add the luminance signal Y with the luminance compensation signal ΔY to produce a compensated luminance signal Y′. For example, step 430 is performed by the adder 180 shown in FIG. 1.

Step 440: Subtract the cross color components (formed by the ΔU and ΔV signals) from the chrominance signal C (formed by the U and V signals) to thereby generate a suppressed chrominance signal (formed by the U′ and V′ signals). For example, step 440 is performed by the subtracting module 140 shown in FIG. 1.

The apparatus and method for eliminating the cross color effect disclosed according to the present invention not only suppress the influence of the cross color effect on a chrominance signal, but also perform a compensation for the influence of the cross color effect on a luminance signal. After undergoing processing according to the present invention apparatus or method, influences of the cross color effect are eliminated on both the luminance portion and chrominance portion of a video signal. Because of this, the overall quality of a resulting video signal is increased.

Those skilled in the art will readily observe that numerous modifications and alterations of the device and method may be made while retaining the teachings of the invention. Accordingly, the above disclosure should be construed as limited only by the metes and bounds of the appended claims.

1. A cross color effect elimination apparatus for utilizing a first carrier wave to eliminate a cross color effect from a video signal, wherein the video signal comprises a chrominance signal and a luminance signal, and the cross color effect elimination apparatus comprises:
a cross color estimator coupled to the video signal for estimating a cross color component of the video signal;
a modulator coupled to the cross color estimator and the first carrier wave for utilizing the first carrier wave to convert the cross color component into a luminance compensation component; and
an adder coupled to the luminance signal and the modulator for adding the luminance signal to the luminance compensation component to thereby generate a compensated luminance signal.

2. The cross color effect elimination apparatus of claim 1, further comprising:
a subtractor module coupled to the chrominance signal and the cross color estimator for subtracting the cross color component from the chrominance signal to thereby produce a suppressed chrominance signal.

3. The cross color effect elimination apparatus of claim 2, wherein the subtractor module further comprises:
a first subtractor for subtracting a cross color U component of the cross color component from a U signal of the chrominance signal; and
a second subtractor for subtracting a cross color V component of the cross color component from a V signal of the chrominance signal.

4. The cross color effect elimination apparatus of claim 1, wherein the modulator further comprises:
a first multiplier for multiplying a cross color U component of the cross color component with a second carrier wave, wherein the second carrier wave and the first carrier wave have a 90 degree phase difference;
a second multiplier for multiplying a cross color V component of the cross color component with the first carrier wave; and
a first adder for outputting the luminance compensation component;
wherein the adder module comprises a second adder coupled to the luminance signal and the first adder.

5. The cross color effect elimination apparatus of claim 4, wherein the first adder is coupled to the first multiplier and the second multiplier for generating the luminance compensation component by adding the output of the first multiplier to the output of the second multiplier.

6. The cross color effect elimination apparatus of claim 4, wherein the modulator further comprises a third multiplier coupled to the second multiplier for performing processing according to a Europea video signal standard, the first adder being coupled to the first multiplier and the third multiplier for adding the outputs of the first multiplier and the third multiplier to thereby generate the luminance compensation component.

7. The cross color effect elimination apparatus of claim 1, wherein the cross color estimator is for determining the cross color components of the chrominance signal according to a two dimensional or a three dimensional phase relationship of the chrominance signal.

8. A cross color effect processing apparatus for processing a cross color effect of a video signal, wherein the video signal comprises a chrominance signal and a luminance signal, and the cross color effect processing apparatus comprises:
a feature extractor coupled to the luminance signal for extracting a candidate component that is responsible for causing the cross color effect;
a demodulator coupled to the feature extractor for utilizing a first carrier wave to convert the candidate component to a candidate cross color component;
a cross color estimator coupled to the chrominance signal for estimating a chrominance cross color component corresponding to the chrominance signal;
a phase detector coupled to the demodulator and the cross color estimator for comparing the candidate cross color component and the chrominance cross color component, and for outputting a corresponding difference signal; and
a feedback circuit coupled to the phase detector and the demodulator for generating a first carrier wave according to the difference signal.

9. The cross color effect processing apparatus of claim 8, further comprising a phase rotator coupled to the demodulator and the phase detector for performing a phase rotation when processing according to Europea video signal standards.

10. The cross color effect processing apparatus of claim 8, wherein the feature extractor is a device for filtering out components that may cause the cross color effect from the luminance signal such as band pass filter, a two dimensional boundary line or a diagonal line detecting apparatus.

11. The cross color effect processing apparatus of claim 8, wherein the demodulator comprises:
a first multiplier for multiplying the candidate component and the first carrier wave; a second multiplier for multiplying the candidate component with a second carrier wave, wherein the second carrier wave and the first carrier wave have a phase difference of 90 degrees;
a first filter for performing a filtering operation on the output of the first multiplier; and
a second filter for performing a filtering operation on the output of the second filter.

12. The cross color effect processing apparatus of claim 8, wherein the feedback circuit comprises:
a synchronization device for adjusting a phase of the first carrier wave according to the difference signal;
a waveform generator coupled to the synchronization device for generating the first carrier wave; and
a phase rotator coupled to the waveform generator for generating the second carrier wave by rotating the phase of the first wave signal by 90 degrees.

13. The cross color effect processing apparatus of claim 12, wherein the synchronization device is a phase lock loop.

14. The cross color effect processing apparatus of claim 12, wherein the synchronization device is coupled between the phase detector and the waveform generator for adjusting the phase or frequency of the first carrier wave generated by the waveform generator according to the difference signal.

15. The cross color effect processing apparatus of claim 12, wherein the cross color estimator generates a gain signal according to a size of the estimated cross color component, the feedback circuit further comprises a third multiplier for multiplying the gain signal and the difference signal, and the synchronization device is coupled to the third multiplier and the waveform generator for adjusting the phase or frequency of the first carrier wave generated by the waveform generator according to the output of the third multiplier.

16. The cross color effect processing apparatus of claim 8, wherein the cross color estimator is for determining cross color components of the chrominance signal according to a two dimensional or a three dimensional phase relationship of the chrominance signal.

17. The cross color effect processing apparatus of claim 8, further comprising:
a modulator coupled to the cross color estimator and the feedback circuit for utilizing the first carrier wave to convert the cross color component to a luminance compensation component; and
an adder module coupled to the luminance signal and the modulator for adding the luminance signal to the luminance compensation component to thereby produce a compensated luminance signal.

18. The cross color effect processing apparatus of claim 17, further comprising:
a subtractor module coupled to the chrominance signal and the cross color estimator for subtracting the cross color component from the chrominance signal to thereby produce a suppressed chrominance signal.

19. The cross color effect processing apparatus of claim 18, wherein the subtractor module further comprises:
a first subtractor for subtracting a cross color U component of the cross color component from a U signal of the chrominance signal; and
a second subtractor for subtracting a cross color V component of the cross color components from a V signal of the chrominance signal.

20. The cross color effect processing apparatus of claim 17, wherein the modulator further comprises:
a fourth multiplier for multiplying a cross color U component of the cross color component with a second carrier wave, wherein the second carrier wave and the first carrier wave have a 90 degree phase difference;
a fifth multiplier for multiplying a cross color V component with the first carrier wave; and
a first adder for outputting a luminance compensation component;
wherein the adder module comprises a second adder coupled to the luminance signal and the first adder.

21. The cross color effect processing apparatus of claim 20, wherein the first adder module is coupled to the fourth multiplier and the fifth multiplier for adding the outputs of the fourth multiplier and the fifth multiplier to thereby generate the luminance compensation component.

22. The cross color effect processing apparatus of claim 20, wherein the modulator further comprises a sixth multiplier coupled to the fifth multiplier for performing processing according to a Europea video signal standard, the first adder being coupled to the fourth and the sixth multipliers for adding the output of the fourth multiplier to the output of the sixth multiplier to thereby generate the luminance compensation component.

23. A method of cross color effect elimination for eliminating a cross color effect from a video signal, the video signal comprising a chrominance signal and a luminance signal, and the method comprising the following steps:
(a) estimating a cross color component from the chrominance signal;
(b) utilizing a first carrier wave to convert the cross color component to a luminance compensation component, wherein the first carrier wave and a carrier wave used during demodulation of the video signal have the same frequency and phase; and
(c) adding the luminance signal with the luminance compensation component to thereby generate a compensated luminance signal.

24. The method of claim 23, further comprising the following step:
(d) subtracting the cross color component from the chrominance signal to thereby generate a suppressed chrominance signal.
